(19) United States
(12) Patent Application Publication
(10) Pub. No.: US 2018/0216770 A1
(43) Pub. Date: Aug. 2, 2018

(54) QUICK CONNECTOR WITH PRESSURE DIFFERENTIAL ZONES

(71) Applicant: FASTEST, INC., Roseville, MN (US)

(72) Inventors: Robert DANIELSON, Roseville, MN (US); Chris WAGNER, Roseville, MN (US)

(21) Appl. No.: 15/883,321

(22) Filed: Jan. 30, 2018

Related U.S. Application Data
(60) Provisional application No. 62/452,064, filed on Jan. 30, 2017.

(51) Int. Cl. F16L 37/44; F16L 37/138; F16L 37/12

(52) U.S. Cl. CPC F16L 37/44; F16L 37/1235; F16L 37/138

(57) ABSTRACT

A quick connect fluid connector that acts as the connection between a filling line and a gas cylinder for use in gas filling and/or evacuation processes. The fluid connector supplies a gas or vacuum to one or more typical sealing zones of the fluid connector to create one or more pressure differential zones having a pressure that is greater than ambient pressure to act as a barrier to prevent ingress of contaminants into the primary flow of gas through the fluid connector or less than ambient pressure to prevent egress of gas from the primary flow of gas into the surrounding environment.

### FIELD

This disclosure relates to a quick connect fluid connector that can be used to, for example, connect a first fluid system with a second fluid system for transferring gases between the first and second fluid systems.

### BACKGROUND

Due to sealing limitations, conventional quick connectors cannot be used in certain gas processing operations because conventional quick connectors permit leakage of the gas being processed through the quick connector into the ambient environment or permit the introduction of contaminants, such as ambient air or other contaminants, into the gas being processed through the quick connector.

For example, in high purity gas cylinder filling, the industry uses non-quick connectors which require greater effort, time, and labor to achieve connection and filling compared to quick connectors. Non-quick connectors are only used at the present time for high purity gas filling since all commercially available quick connectors allow some infiltration of non-desirable gases like ambient air into the high purity gas flowing through the quick connector which results in the spoilage of the high purity gas or the inability to achieve required vacuum in the gas cylinder before filling.

Similarly, if the gas being processed is a gas that should not be leaked to the ambient environment, such as an environmentally harmful gas, a conventional quick connector would allow some portion of the gas to leak past the seals due to the sealing limitations of the quick connector.

### SUMMARY

A quick connect fluid connector is described that acts as the temporary connection between first and second fluid systems, and a gas is processed through the quick connect fluid connector between the first and second fluid systems. The first fluid system can be, for example, a filling/evacuation line connected to the quick connect fluid connector, and the second fluid system can be, for example, a gas cylinder that stores the gas being processed. The quick connect fluid connector described herein can be used in gas cylinder filling and/or evacuation processes.

The quick connect fluid connector described herein supplies a gas or vacuum to one or more typical sealing zones of the fluid connector to create one or more pressure differential zones. In the case of a gas being supplied to the one or more typical sealing zones of the connector, the resulting pressure differential zone(s) has a pressure that is greater than ambient pressure so that unwanted impurities like air or other contaminants are preferentially and controllably blocked from entering a main flow of gas flowing through the quick connect fluid connector from ambient. The pressure differential zone(s) in this embodiment may be referred to as a positive pressure differential zone(s) since the pressure of the pressure differential zone is greater than ambient pressure. The gas used to create the one or more positive pressure differential zone(s) can be the same type of gas forming the main gas flow, or a gas that is a different type of gas forming the main gas flow, through the connector. With the positive pressure different zone(s), even if the seals of the quick connect fluid connector leak during filling or deep vacuum, infiltration of unwanted, ambient gases such as air isn't possible due to the pressure differential of the positive pressure differential zone(s) that is created in a typical sealing zone of the quick connect fluid connector.

In the case of a vacuum being supplied to the one or more typical sealing zones of the fluid connector via a secondary flow path, the resulting pressure differential zone(s) has a pressure that is less than ambient pressure. The pressure differential zone(s) in this embodiment may be referred to as a negative pressure differential zone(s) since the pressure of the pressure differential zone is lower than ambient pressure. With the negative pressure different zone(s), any leakage of gas past the seals from the primary flow path through the quick connect fluid connector during filling or vacuum is prevented from leaking to the ambient environment by the applied vacuum in the secondary flow path.

In one non-limiting embodiment, the gases being processed through the quick connect fluid connectors can be high purity gases. High purity gases described herein have magnitudes difference in purity levels versus standard gases of the same composition. Using oxygen as an example, high purity oxygen could be 99.99990% oxygen and 0.0001% trace gas versus standard oxygen at 99.97% oxygen and 0.03% trace gas. The term “high purity gas” used herein, unless indicated otherwise, refers to gases that have a purity level that is greater than the standard purity level of the same gas. In one embodiment, the purity level is greater than 99.97%. In another embodiment, the purity level can be 99.99990% or more. The high purity gases can include, but are not limited to, oxygen, argon, helium, hydrogen, nitrogen, neon, krypton, xenon and other gases for which a high purity is desired and where a fluid connector is used during filling and/or evacuation processing involving the high purity gas. In the case of high purity gases, the creation of one or more positive pressure differential zone(s) in the quick connect fluid connector may be the most suitable although the creation of one or more negative pressure differential zone(s) may also be used.

In another non-limiting embodiment, the gases being processed through the quick connect fluid connectors described herein can be gases that are considered harmful to the environment if leaked to the environment that should be reclaimed, or other non-environmentally harmful gases that one may otherwise wish to reclaim and prevent release to the ambient environment. Non-limiting examples of such gases include, but are not limited to, carbon dioxide, methane, nitrous oxide, ozone, smog, nitrogen, and others. In the case of environmentally harmful gases, the creation of one or more negative pressure differential zone(s) in the quick connect fluid connector may be the most suitable although the creation of one or more positive pressure differential zone(s) may also be used.

The pressure differential zone(s) concepts described herein can be applied to any quick connect fluid connector having any particular design, allowing any quick connect fluid connector to be used in gas filling and/or evacuation processes.

In one embodiment, a method of gas processing through a quick connect fluid connector includes connecting the quick connect fluid connector to a fluid system to process a gas into or from the fluid system through the quick connect fluid connector. Once connected, a flow of the gas is directed through a primary flow path of the quick connect fluid connector into or from the fluid system. While the gas is flowing through the primary flow path, a first pressure differential zone is created within a sealing zone of the quick connect fluid connector by directing a flow of gas or vacuum to the sealing zone through a secondary flow path of the quick connect fluid connector, where the first pressure differential zone has a pressure that differs, either greater than or less than, from ambient pressure.

When the first pressure differential zone has a pressure that is greater than ambient pressure, the first pressure differential zone acts as a barrier to prevent ambient impurities, including but not limited to ambient gas such as air, from leaking into the gas flowing through the primary flow path. When the first pressure differential zone is created by the same type of gas that is flowing through the primary flow path, any leaking that does occur is of the gas from the first pressure differential zone, so that the gas leaking into the primary flow path does not contaminate the gas flowing therethrough.

When the first pressure differential zone has a pressure that is less than ambient pressure, created by applying a vacuum at the first pressure differential zone, the first pressure differential zone acts as a barrier to prevent the gas that is flowing through the primary flow path from leaking into the surrounding ambient environment.

In another embodiment, a quick connect fluid connector that is detachably connectable to a fluid system to process a gas into or from the fluid system through the quick connect fluid connector is provided. The quick connect fluid connector includes a connection mechanism having a connected position to detachably connect the quick connect fluid connector to the fluid system and disconnected position to disconnect the quick connect fluid connector from the fluid system. An actuator is connected to the connection mechanism to actuate the connection mechanism between the connected position and the disconnected position. A primary flow path is defined through the quick connect fluid connector for the gas to flow through while the gas is processed into or from the fluid system. In addition, a first seal is disposed along a first sealing zone of the quick connect fluid connector, where the first seal may be in fluid communication with ambient pressure via the first sealing zone. In addition, a secondary flow path extends to the first seal and is fluidly connectable to a source of gas or to vacuum to create a first pressure differential zone adjacent to the first seal, where the first pressure differential zone has a pressure that differs, either greater than or less than, from ambient pressure.

### DRAWINGS

FIG. 1 is a perspective view of an example quick connect fluid connector described herein in position to be connected to a valve of a gas cylinder.

FIG. 2 is a perspective view of the example quick connect fluid connector of FIG. 1 connected to the valve of the gas cylinder.

FIG. 3 is a longitudinal cross-sectional view of the example quick connect fluid connector described herein.

FIG. 4 is a view similar to FIG. 3 that shows a flow of gas (indicated by arrows) through a secondary flow path of the quick connect fluid connector to create one or more positive pressure differential zones.

FIG. 5 is a close-up view of the area contained within the circle A in FIG. 3 showing a positive pressure differential zone at a rear seal of the quick connect fluid connector.

FIG. 6 is a close-up view of the area contained within the circle B in FIG. 3 showing a positive pressure differential zone at a front seal of the quick connect fluid connector.

FIGS. 7A and 7B are perspective and cross-sectional views, respectively, of areas similar to FIG. 6 but showing an alternative embodiment that uses a single-piece seal as the front seal.

FIG. 8 illustrates an example evacuation mode of operation of the quick connect fluid connector evacuating the gas cylinder, with gas flowing through a primary flow path and gas flowing through the secondary flow path to create the positive pressure differential zones.

FIG. 9 illustrates an example filling mode of operation of the quick connect fluid connector filling the gas cylinder, with gas flowing through a primary flow path and gas flowing through the secondary flow path to create the positive pressure differential zones.

FIG. 10 illustrates an example evacuation mode of operation of the quick connect fluid connector evacuating the gas cylinder, with a vacuum applied through the secondary flow path to create negative pressure differential zones.

FIG. 11 illustrates an example filling mode of operation of the quick connect fluid connector filling the gas cylinder, with a vacuum applied through the secondary flow path to create negative pressure differential zones.

FIGS. 12 and 13 are views similar to FIGS. 5 and 6, respectively, but showing the creation of negative pressure differential zones using a vacuum.

FIG. 14 illustrates a conventional quick connect fluid connector of the type similar to FIG. 1.

### DETAILED DESCRIPTION

A quick connect fluid connector described herein acts as the temporary connection between a filling line and a gas cylinder where the quick connect fluid connector can be used in gas filling and/or evacuation processes. The quick connect fluid connectors described herein use a gas or vacuum to create one or more pressure differential zones in one or more typical sealing zones of the connector. The pressure differential zone(s) has a pressure that differs (either greater than or less than) from ambient pressure to act as a barrier to either the introduction of unwanted impurities like air or other contaminants from the ambient environment into the main gas flow through the connector, or to act as a barrier to prevent leakage of gas from the main gas flow through the connector into the ambient environment.

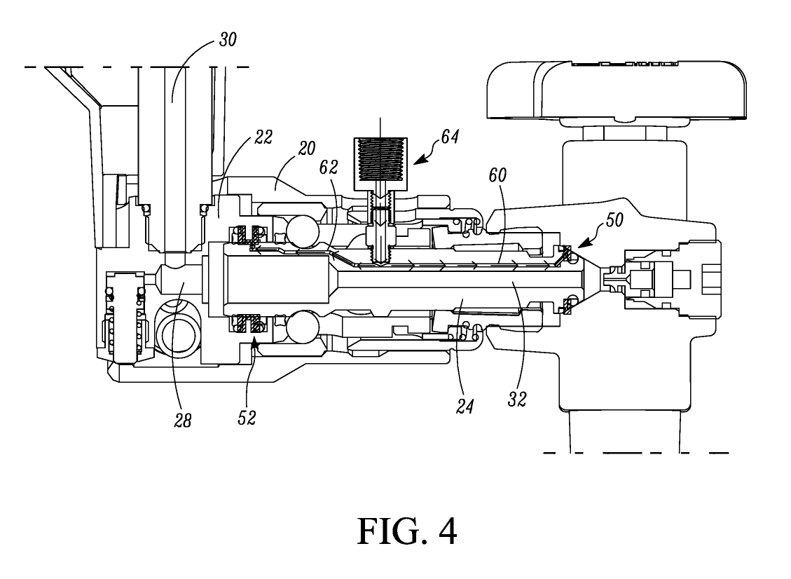

In one embodiment described below with respect to FIGS. 4-9, a gas can be supplied to the one or more typical sealing zones of the fluid connector to create the resulting pressure differential zone(s) each of which has a pressure that is greater than ambient pressure so that unwanted impurities like air or other contaminants are preferentially and controllably blocked from entering a main flow of gas flowing through the quick connect fluid connector. The pressure differential zone(s) in this embodiment may be referred to as a positive pressure differential zone(s). The gas used to create the one or more positive pressure differential zone(s) can be the same type of gas forming the main gas flow, or a gas that is a different type of gas forming the main gas flow, through the connector. With the positive pressure different zone(s), even if the seals of the quick connect fluid connector leak during filling or deep vacuum, infiltration of unwanted, ambient gases such as air or other impurities isn't possible due to the pressure differential of the positive pressure differential zone(s) that is created.

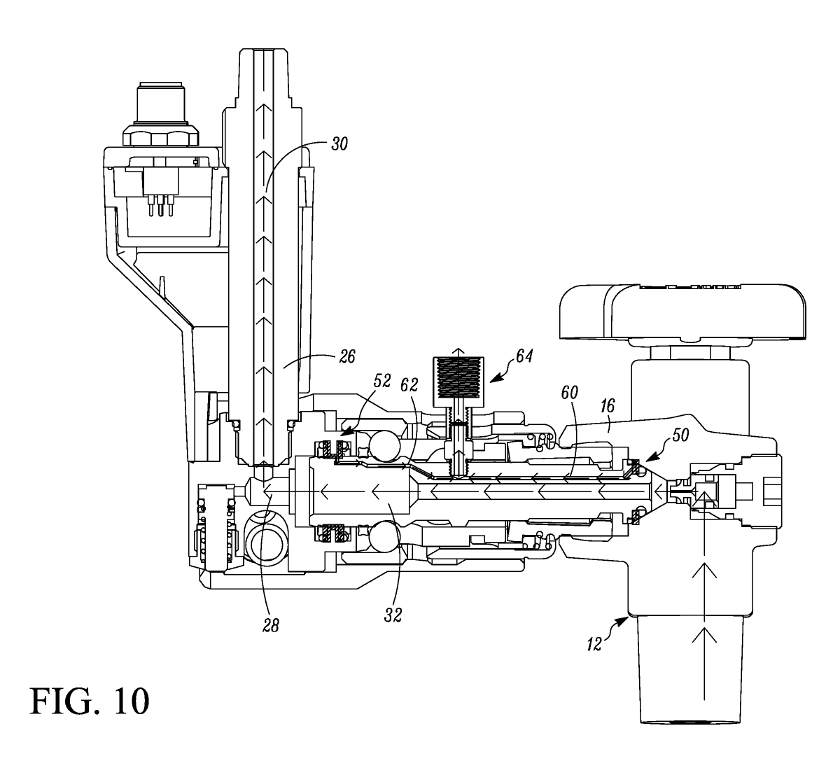

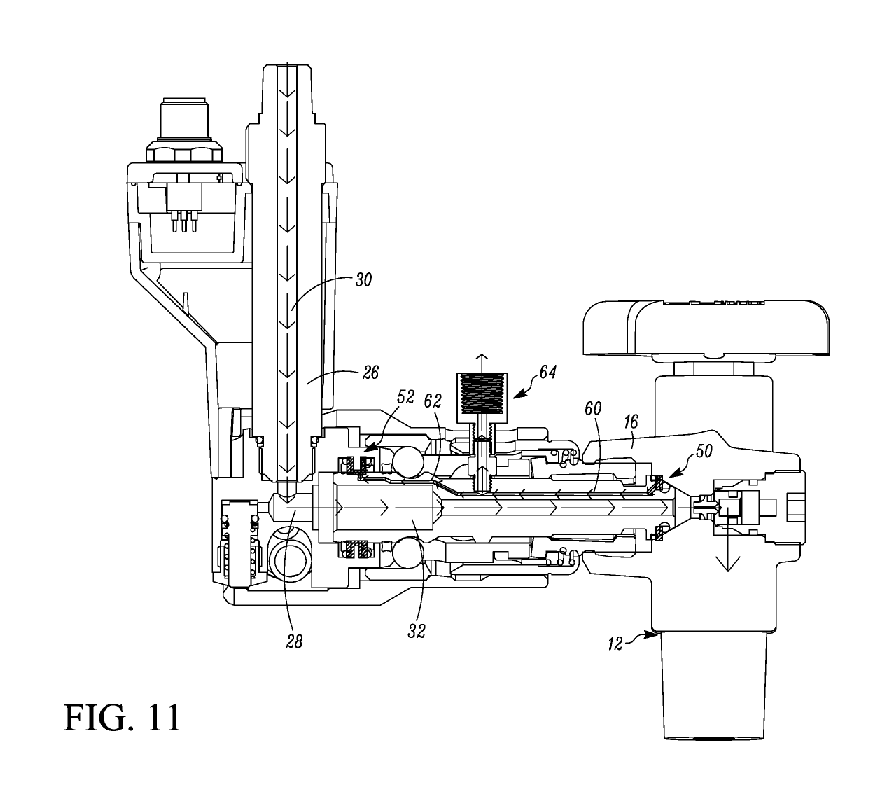

In another embodiment described below with respect to FIGS. 10-11, a vacuum can be supplied via a secondary flow path to the one or more typical sealing zones of the fluid connector to create the resulting pressure differential zone(s) each of which has a pressure that is less than ambient pressure. The pressure differential zone(s) in this embodiment may be referred to as a negative pressure differential zone(s). With the negative pressure different zone(s), any leakage of gas past the seals from the primary flow path through the quick connect fluid connector during filling or vacuum is prevented from leaking to the ambient environment by the applied vacuum in the secondary flow path.

In one non-limiting embodiment, the gases being processed through the quick connect fluid connectors can be high purity gases. High purity gases described herein have magnitudes difference in purity levels versus standard gases of the same composition. Using oxygen as an example, high purity oxygen could be 99.99990% oxygen and 0.0001% trace gas versus standard oxygen at 99.97% oxygen and 0.03% trace gas. The term “high purity gas” used herein, unless indicated otherwise, refers to gases that have a purity level that is greater than the standard purity level of the same gas. In one embodiment, the purity level is greater than 99.97%. In another embodiment, the purity level can be 99.99990% or more. The high purity gases can include, but are not limited to, oxygen, argon, helium, hydrogen, nitrogen, neon, krypton, xenon and other gases for which a high purity is desired and where a fluid connector is used during filling and/or evacuation processing involving the high purity gas.

In the case of high purity gases, the creation of one or more positive pressure differential zone(s) in the quick connect fluid connector may be the most suitable although the creation of one or more negative pressure differential zone(s) may also be used. For example, in the specific case of high purity gases, the resulting pressure differential zone(s) can have a pressure that is greater than ambient so that unwanted impurities like air or other contaminants are preferentially and controllably blocked from entering a main flow of high purity gas flowing through the quick connect fluid connector. When the pressure differential zone(s) are created using the same high purity gas as the main gas flow through the connector, high purity gas from the pressure differential zone(s), instead of unwanted impurities like air or other contaminants, may be preferentially and controllably leaked into the primary flow of the same high purity gas through the quick connect fluid connector.

In another non-limiting embodiment, the gases being processed through the quick connect fluid connectors described herein can be gases that are considered harmful to the environment if leaked to the environment. Non-limiting examples of such gases include, but are not limited to, carbon dioxide, methane, nitrous oxide, ozone, smog, and others. In the case of environmentally harmful gases, the creation of one or more negative pressure differential zone(s) in the quick connect fluid connector may be the most suitable although the creation of one or more positive pressure differential zone(s) may also be used.

The pressure differential zone concepts described herein can be applied to any quick connect fluid connector having any particular design, allowing any quick connect fluid connector to be used in gas filling and/or evacuation processes. For sake of convenience in explaining the concepts described herein, a specific example of a quick connect fluid connector is described and illustrated herein. However, the concepts described herein can be used on any other type of quick connect fluid connector that one may wish to use for gas processing (filling and/or evacuating).

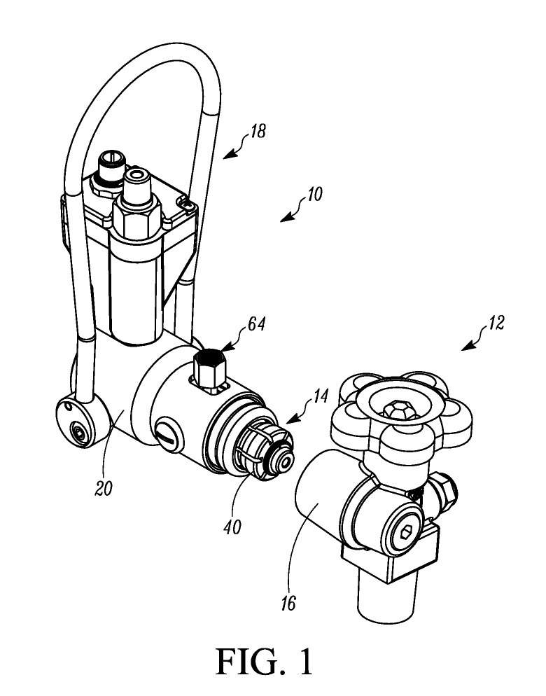

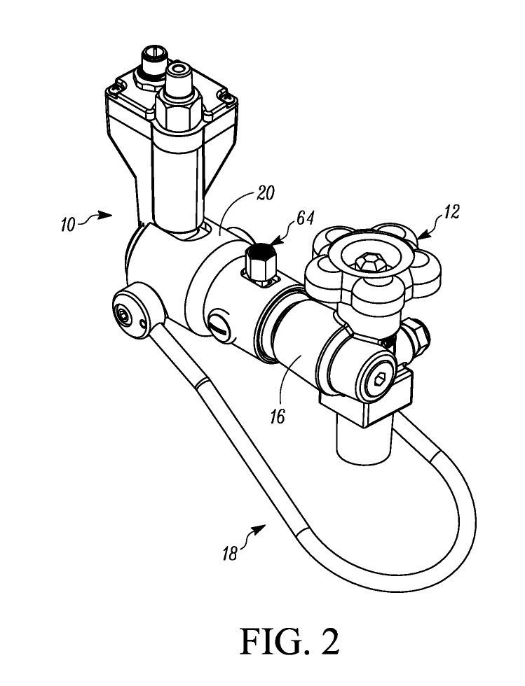

Referring initially to FIGS. 1 and 2, an example quick connect fluid connector 10 is illustrated along with a cylinder valve 12. The fluid connector 10 is somewhat similar in construction and operation to the G580 quick connector available from FasTest Inc. of Roseville, Minn. In addition, further information on a somewhat similar fluid connector of this type, as well as its operation, can be found in U.S. Pat. No. 8,844,979 which is incorporated herein by reference in its entirety.

The cylinder valve 12 is conventional in construction and is attached to a gas cylinder (not shown) forming a fluid system that is to be filled with a gas and where the fluid connector 10 is used during filling and/or evacuation processing involving the gas. The valve 12 controls the ingress and egress of gas to and from the cylinder.

The fluid connector 10 has a suitable connection means 14 that can be actuated to achieve a temporary, sealed connection with a port 16 of the cylinder valve 12 through which the gas is introduced into or discharged from the gas cylinder. An interior (or exterior) surface of the port 16 is provided with threads or other conventional structure for engagement by the connection means 14 of the connector 10. Examples of suitable connection means 14 include, but are not limited to, externally threaded collets that are engageable with internal threads of the port 16 (as illustrated in the figures herein and described in U.S. Pat. No. 8,844,979), internally threaded collets that are engageable with external threads on the port 16 (as described in U.S. Pat. No. 8,844,979), unthreaded collets, connection means like those described in U.S. Pat. No. 5,507,537, connection means like those described in U.S. Pat. No. 5,343,798, and other types of connection means known in the art. A specific example of a connection means 14 in the form of externally threaded collets will be described in further detail below.

The connection means 14 is actuated by a suitable manual actuation means 18 known in the art to achieve connection and disconnection. In the example illustrated in FIGS. 1 and 2, the actuation means 18 comprises a handle, for example a bail handle. However, other types of manual actuation means 18 known in the art, such as levers, can be used. In addition, motorized or fluid-actuated actuation mechanisms known in the art can be used.

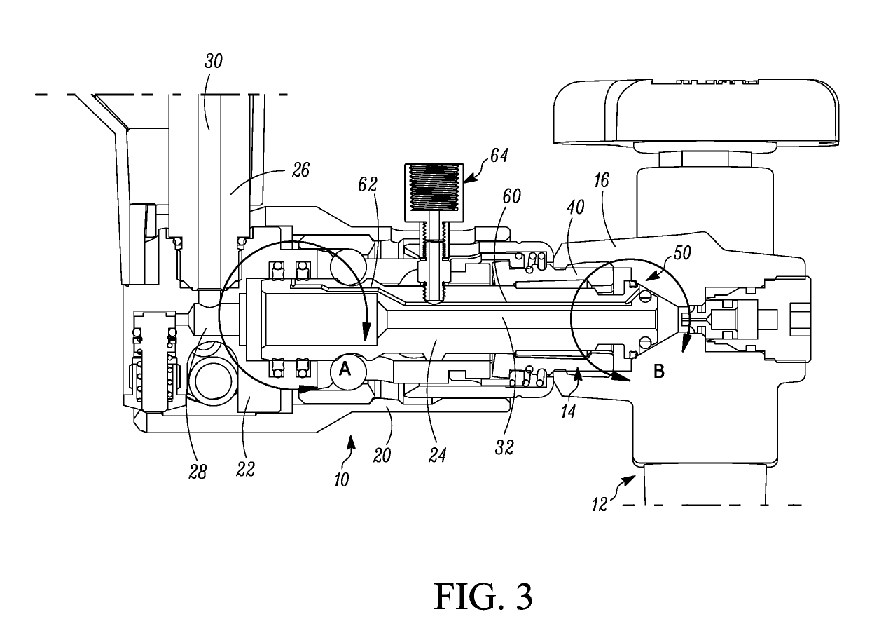

With reference to FIG. 3, further details of the fluid connector 10 will be described. The fluid connector 10 generally includes a cylindrical outer sleeve 20 that defines a longitudinal axis, a main body 22, a piston 24, in addition to the connection means 14 that forms a connection mechanism 14, and the actuation means 18 (see FIGS. 1-2) that forms part of an actuator 18 that is connected to the connection mechanism 14 to actuate the connection mechanism 14. Further information on the construction and operation of the sleeve 20, the main body 22, the piston 24, the connection means 14 (both externally threaded collets and internally threaded collets) and the actuation means 18 can be found in U.S. Pat. No. 8,844,979 which is incorporated herein by reference in its entirety.

The main body 22 is a cylindrical member and is disposed at least partially in and surrounded by the sleeve 20. A nipple 26 is fixed to the main body 22 that defines a fluid port and that projects beyond an exterior of the cylindrical sleeve 20. The main body 22 and the sleeve 20 are slideable relative to one another parallel to the longitudinal axis. The main body 22 defines a fluid passageway 28 that is in fluid communication with a fluid passageway 30 of the nipple 26 so that gas can flow between the nipple 26 and the fluid passageway 28.

The piston 24 is a cylindrical member that is disposed at least partially within the main body 22, and the piston 24 is slideable relative to the main body 22 parallel to the longitudinal axis. The piston 24 defines a fluid passageway 32 that extends therethrough from one end to the other and is in fluid communication with the fluid passageway 28 of the main body 22. The fluid passageways 28, 30, 32 define a primary flow path for the gas through the fluid connector 10. As described in U.S. Pat. No. 8,844,979, a spring (not shown) acts on the piston 24 to bias the piston 24 in a direction toward the right in FIG. 3, i.e. toward the valve 12.

The connection mechanism 14 is illustrated as including a plurality of collets 40 that are mounted on the main body 22 and surround the end of the piston 24. The collets 40 are actuatable from a collapsed or disconnected position (shown in FIG. 1) to an expanded or connected position (shown in FIG. 3) connected to the port 16. The exterior surfaces of the collets 40 are formed with threads (best seen in FIG. 1) that grip with internal threads formed on the interior surface of the port 16. This construction and operation of the collets 40 and actuation of the collets 40 is conventional and would be well understood by persons of ordinary skill in the art.

The actuator 18 actuates the collets 40 from the collapsed or disconnected position in FIG. 1 to the expanded or connected position shown in FIG. 3. The actuator 18 can be similar in construction and operation to the actuation mechanism described in U.S. Pat. No. 8,844,979.

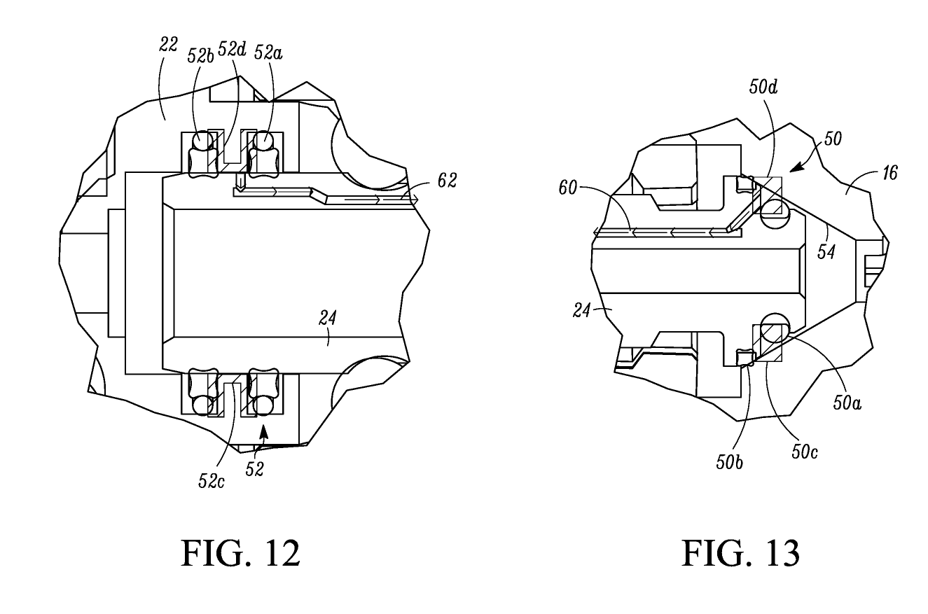

Referring to FIG. 3, the front end of the piston 24 includes a seal 50 that is configured to seal with an internal surface of the port 16 when connected. In addition, a seal 52 is located between an outer surface of the piston 24 and an interior surface of the main body 22. The seals 50, 52 are located at areas of the fluid connector 10 where leaks may occur that could allow unwanted impurities like air or other contaminants from the ambient environment to reach the primary flow path through the fluid connector 10 or where gas flowing through the fluid connector 10 could leak to the ambient environment. To prevent such leakage, a pressure differential zone is created adjacent to one or both of the seals 50, 52, where each pressure differential zone has a pressure that differs from ambient pressure. As described further below with respect to FIG. 4-9, the pressure differential zone(s) can have a pressure that is greater than ambient pressure by directing a flow of gas to the pressure differential zone(s). Alternatively, as described further below with respect to FIG. 10-13, the pressure differential zone(s) can have a pressure that is less than ambient pressure by applying a vacuum to the pressure differential zone(s).

The pressure differential zones can be created adjacent to the seals 50, 52 in any suitable manner using any suitable flow path in the fluid connector 10. In the one non-limiting example illustrated in FIG. 3, a first secondary flow path 60 and a second secondary flow path 62 are formed in the piston 22 generally parallel to the longitudinal axis and extend to the seals 50, 52 respectively. The flow paths 60, 62 are in communication with a port 64 that extends through the sleeve 20, the main body 22 and into the piston 24 so as to be in fluid communication with the flow paths 60, 62. The flow paths 60, 62 can be formed by one or more passageways through the piston 24 (or through other elements of the fluid connector 10) that lead to the seals 50, 52. In use, the port 64 is connected to a source of gas (when creating a positive pressure differential zone) or to a vacuum source (when creating a negative pressure differential zone). Alternatively, the gas for flowing through the flow paths 60, 62 or the vacuum can be provided from a separate gas feed or vacuum source.

Referring to FIG. 4-9, in the case of the positive pressure differential zone(s), a flow of gas can be directed into the port 64 and through either or both of the flow paths 60, 62 to one or both of the seals 50, 52. In the illustrated example, a flow of gas is directed through each of the flow paths 60, 62 to create a positive pressure differential zone adjacent to each of the seals 50, 52. The gas in the zones adjacent to the seals 50, 52 is at a pressure greater than ambient pressure surrounding the fluid connector 10. Accordingly, the positive pressure differential zones prevent unwanted impurities like air or other contaminants from flowing past the seals 50, 52 and into the primary flow path of the fluid connector 10.

In one non-limiting example, the gas flowing through the fluid connector 10 can be a high purity gas, and the gas used to create the positive pressure differential zones can be the same high purity gas that is flowing through the primary flow path. Accordingly, any of the high purity gas from the positive pressure differential zones that leaks past the seals 50, 52 and into the primary flow path of the high purity gas through the fluid connector 10 does not contaminate the high purity gas in the primary flow path.

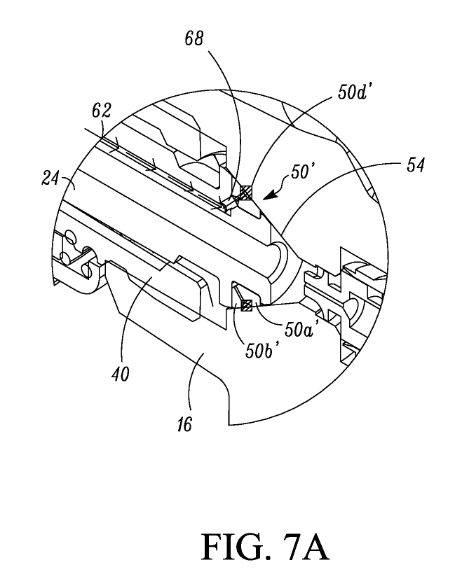

In one non-limiting example best seen in FIGS. 4 and 6, the seal 50 can include first and second spaced seals 50a, 50b that define first and second spaced sealing surfaces defining a space 50c therebetween. The secondary flow path 60 opens into and is in fluid communication with the space 50c so that the gas is introduced into the space 50c. The gas creates a positive pressure differential zone 50d (indicated schematically by a rectangle with slanted lines) in the space 50c and between where the surfaces of the two seals 50a, 50b seal with the interior surface 54 of the port 16. The zone 50d preferably extends 360 degrees around the entire circumference to create a continuous 360 degree barrier against contaminants. The zone 50d is illustrated in FIGS. 4 and 6 as being much larger than it actually is for ease of visibility and the zone would not extend into any physical structure of the fluid connector.

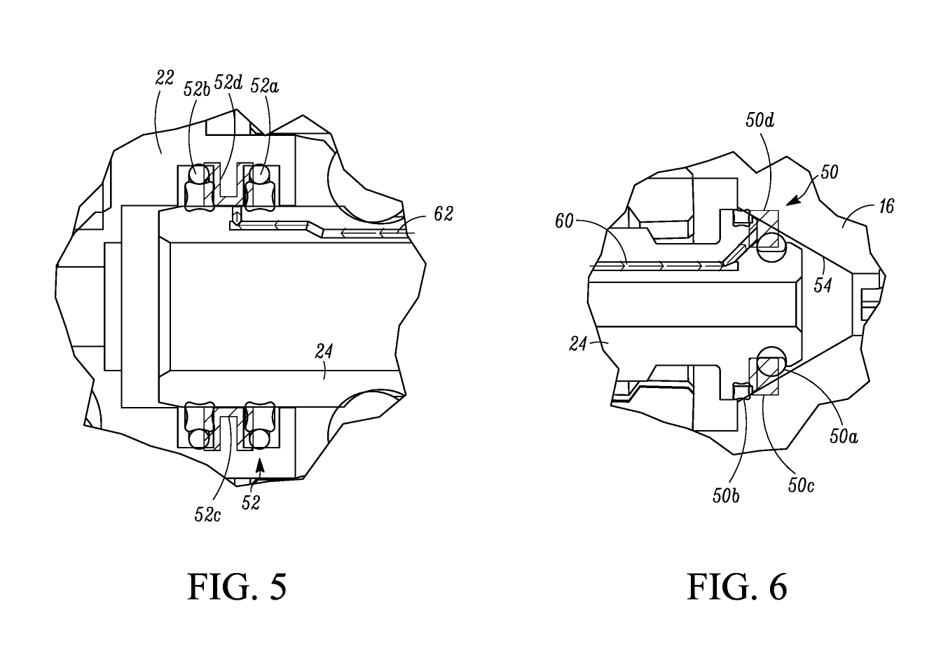

Similarly, as best seen in FIGS. 4 and 5, the seal 52 can include first and second spaced seals 52a, 52b that define first and second spaced sealing surfaces defining a space 52c therebetween. The secondary flow path 62 opens into and is in fluid communication with the space 52c so that the gas is introduced into the space 52c. The gas creates a positive pressure differential zone 52d (indicated schematically with slanted lines) in the space 52c between the two seals 52a, 52b. The zone 52d preferably extends 360 degrees around the entire circumference to create a continuous 360 degree barrier against contaminants. The zone 52d is illustrated as being much larger in FIGS. 4 and 5 than it actually is for ease of visibility and the zone would not extend into any physical structure of the fluid connector 10.

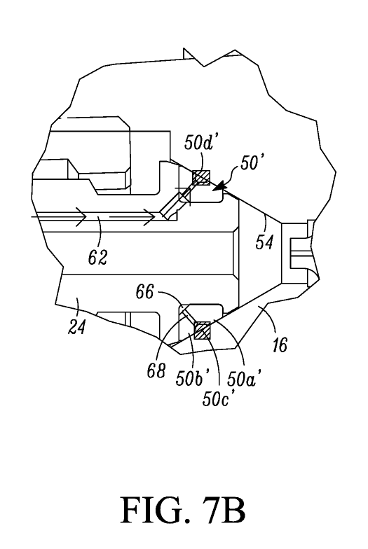

An alternative sealing embodiment is illustrated in FIGS. 7A and 7B. In this embodiment, the seal 50′ is a single, contiguous, one-piece seal element having first and second integral seal portions 50a′, 50b′ that define first and second spaced sealing surfaces that seal with the interior surface 54 and that define a space 50c′ therebetween. The high purity gas flows from the secondary flow path 62 into a circumferential plenum 66 formed between the piston 24 and the base of the seal 50′ and then through circumferentially spaced holes 68 in the seal 50′ into the space 50c′ to create the zone 50d′ of high purity gas. The zone 50d′ (indicated schematically by a rectangle with slanted lines) is illustrated in FIGS. 7A and 7B as being much larger than it actually is for ease of visibility and the zone would not extend into any physical structure of the fluid connector 10.

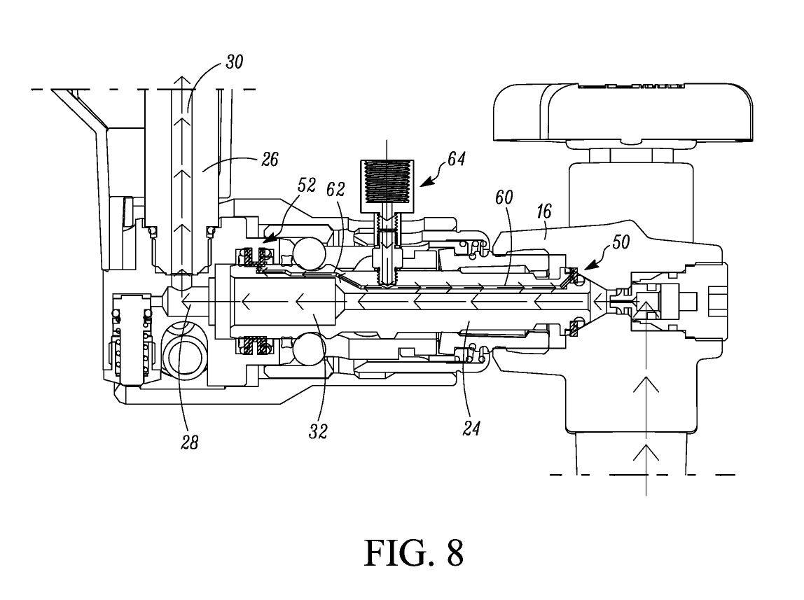

FIG. 8 illustrates an example operation of the fluid connector 10 in an evacuation mode where the gas cylinder 12 is being evacuated. In this embodiment, the fluid connector 10 is connected to the port 16 of the gas cylinder 12 that contains gas therein, and a source of vacuum (not shown) is connected to the nipple 26 to draw the gas from the gas cylinder 12 through the fluid passageways 32, 28, 30 (i.e. through the primary flow path) as depicted by the arrows. At the same time, a flow of gas is introduced through the port 64 and into the secondary flow paths 60, 62. The gas flows through the flow paths 60, 62 to the seals 50, 52 creating the positive pressure differential zones as described above. Any contaminants that may normally leak past the seals 50, 52 and into the primary flow path are blocked by the positive pressure differential zones 50d, 52d (see FIGS. 5 and 6) which are at a higher pressure than the surrounding ambient pressure of the fluid connector 10. In an embodiment where the gas flowing through the primary flow path is a high purity gas, since the gas from the positive pressure differential zones 50d, 52d that may be drawn into the primary flow path can be the same high purity gas that is flowing through the primary flow path, the high purity gas is not contaminated.

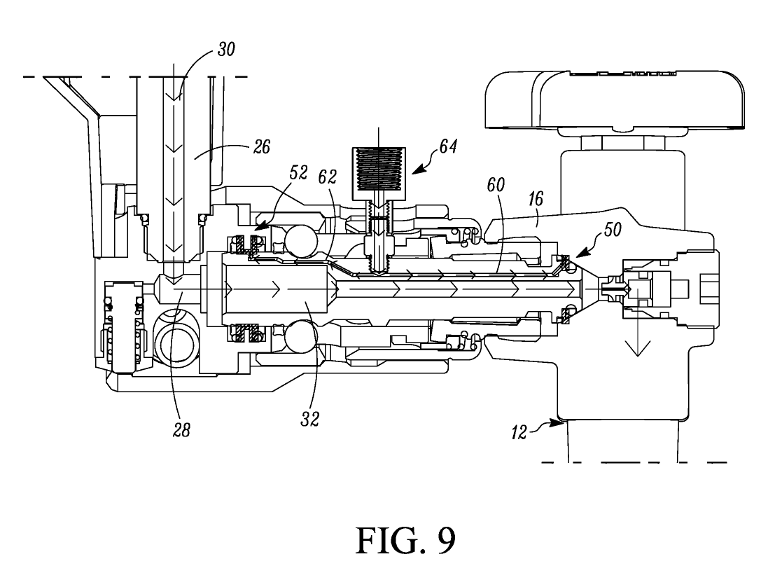

FIG. 9 illustrates an example operation of the fluid connector 10 in a filling mode where the gas cylinder 12 is being filled with a gas. In this embodiment, the fluid connector 10 is connected to the port 16 of the gas cylinder 12 to be filled with the gas, and a source of the gas (not shown) is connected to the nipple 26 to feed the gas to the gas cylinder 12 through the fluid passageways 32, 28, 30 (i.e. through the primary flow path) of the fluid connector 10 as depicted by the arrows. At the same time, a flow of gas is introduced through the port 64 and into the secondary flow paths 60, 62. The gas flows through the flow paths 60, 62 to the seals 50, 52 creating the positive pressure differential zones as described above. Any contaminants that may normally leak past the seals 50, 52 and into the primary flow path are blocked by the positive pressure differential zones 50d, 52d (see FIGS. 5 and 6) which are at a higher pressure than the surrounding ambient pressure of the fluid connector 10. In an embodiment where the gas flowing through the primary flow path is a high purity gas, since the gas from the positive pressure differential zones 50d, 52d that may flow into the primary flow path can be the same high purity gas that is flowing through the primary flow path, the high purity gas is not contaminated.

FIGS. 10 and 12-13 illustrate an example operation of the fluid connector 10 in an evacuation mode where the gas cylinder 12 is being evacuated. In this embodiment, the fluid connector 10 is connected to the port 16 of the gas cylinder 12 that contains gas therein, and a source of vacuum (not shown) is connected to the nipple 26 to draw the gas from the gas cylinder 12 through the fluid passageways 32, 28, 30 (i.e. through the primary flow path) as depicted by the arrows. At the same time, a vacuum is introduced through the port 64 and into the secondary flow paths 60, 62 to the seals 50, 52. The vacuum creates negative pressure differential zones as described above 50d, 52d (see FIGS. 5 and 6). Any gas flowing through the primary flow path that may normally leak past the seals 50, 52 and into the ambient environment is blocked by the negative pressure differential zones 50d, 52d which are at a lower pressure than the surrounding ambient pressure of the fluid connector 10. In addition, any leaking gas is sucked into the flow paths 60, 64 and out through the port 64 to collect the leaking gas.

FIGS. 11-13 illustrate an example operation of the fluid connector 10 in a filling mode where the gas cylinder 12 is being filled with a gas. In this embodiment, the fluid connector 10 is connected to the port 16 of the gas cylinder 12 to be filled with the gas, and a source of the gas (not shown) is connected to the nipple 26 to feed the gas to the gas cylinder 12 through the fluid passageways 32, 28, 30 (i.e. through the primary flow path) of the fluid connector 10 as depicted by the arrows. At the same time, a vacuum is introduced through the port 64 and into the secondary flow paths 60, 62 to the seals 50, 52. The vacuum creates negative pressure differential zones as described above 50d, 52d (see FIGS. 5 and 6). Any gas flowing through the primary flow path that may normally leak past the seals 50, 52 and into the ambient environment is blocked by the negative pressure differential zones 50d, 52d which are at a lower pressure than the surrounding ambient pressure of the fluid connector 10. In addition, any leaking gas is sucked into the flow paths 60, 64 and out through the port 64 to collect the leaking gas.

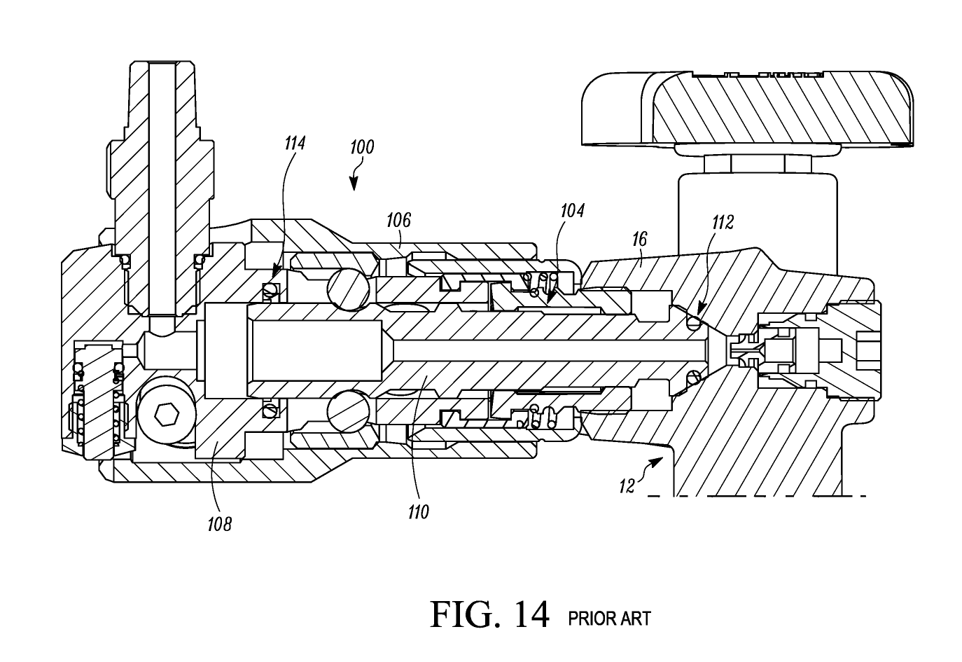

FIG. 14 illustrates a conventional quick connect fluid connector 100 of the type similar to FIG. 1. Like the fluid connector 10, the fluid connector 100 has a connection means 104 that can be actuated to achieve a temporary, sealed connection with the port 16 of the cylinder valve 12 through which the gas is introduced into or discharged from the gas cylinder. The fluid connector 100 further includes a cylindrical outer sleeve 106, a main body 108, and a piston 110. Further information on the construction and operation of the fluid connector 100 can be found in U.S. Pat. No. 8,844,979 which is incorporated herein by reference in its entirety.

The fluid connector 100 differs from the fluid connector 10 in that the fluid connector 100 includes a single seal 112 forming a single sealing surface at the front end of the fluid connector 100, and a single seal 114 forming a single sealing surface between the main body 108 and the piston 110. In addition, the fluid connector 100 does not define secondary flow paths like the flow paths 60, 62 of the fluid connector 10. Therefore, when the fluid connector 100 is used for processing gas, contaminants may be able to flow past the seals 112, 114 and contaminate the gas flowing through the fluid connector 100 or the gas may be able to leak into the ambient environment.

In the embodiments illustrated in FIGS. 1-13, the fluid connector 10 is illustrated as having the two pressure differential zones, one at the front end of the fluid connector 10 adjacent to the seal 50, 50′ and the other adjacent to the seal 52 between the main body 22 and the piston 24. However, the fluid connector 10 can use only a single one of the pressure differential zones or the fluid connector 10 can have more than two of the pressure differential zones.

In one embodiment, the port 64 could also be used for processing during a filling operation of the gas cylinder. This would eliminate the need to connect the nipple 26 to a source of gas.

The secondary flow paths 60, 62 need not be formed in the piston 24. Instead, the secondary flow paths 60, 62 could be formed by any structure that is suitable for directing the gas or vacuum to create the pressure differential zones.

The specific type of fluid connector 10 described herein is an example only. The creation of a pressure differential zone(s) in a flow path as described herein can be applied to any type of fluid connector, including quick connect fluid connector and non-quick connect fluid connectors, that may be used for processing a gas.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of gas processing through a quick connect fluid connector, comprising:
connecting the quick connect fluid connector to a fluid system to process a gas into or from the fluid system through the quick connect fluid connector;
directing a flow of the gas through a primary flow path of the quick connect fluid connector into or from the fluid system; and
while the gas is flowing through the primary flow path, creating a first pressure differential zone within a sealing zone of the quick connect fluid connector by directing a flow of gas or vacuum to the sealing zone through a secondary flow path of the quick connect fluid connector, the first pressure differential zone having a pressure that differs from ambient pressure.

2. The method of claim 1, wherein the sealing zone is past a seal of the quick connect fluid connector, and comprising directing the flow of the gas or the vacuum to the sealing zone adjacent to the seal so that the first pressure differential zone is adjacent to the seal.

3. The method of claim 1, wherein the gas flowing through the primary flow path is a high purity gas; and further comprising creating the first pressure differential zone within the sealing zone by directing a flow of the high purity gas to the sealing zone through the secondary flow path of the quick connect fluid connector so that the first pressure differential zone has a pressure that is greater than ambient pressure.

4. The method of claim 1, further comprising creating the first pressure differential zone within the sealing zone by directing a vacuum to the sealing zone through the secondary flow path of the quick connect fluid connector so that the first pressure differential zone has a pressure that is less than ambient pressure.

5. A method of gas processing through a quick connect fluid connector, comprising:
connecting the quick connect fluid connector to a fluid system to process a gas into or from the fluid system through the quick connect fluid connector;
directing a flow of the gas through a primary flow path of the quick connect fluid connector into or from the fluid system; and
while the gas is flowing through the primary flow path, creating a first pressure differential zone adjacent to a first seal of the quick connect fluid connector by directing a flow of gas or vacuum adjacent to the first seal through a secondary flow path of the quick connect fluid connector, the first pressure differential zone having a pressure that differs from ambient pressure.

6. The method of claim 5, wherein the first seal includes first and second spaced sealing surfaces defining a space therebetween, and comprising directing the flow of the gas or the vacuum through the secondary flow path into the space between the first and second spaced sealing surfaces.

7. The method of claim 5, wherein the first seal is located at an end of the quick connect fluid connector that is in sealing engagement with the fluid system via the first seal.

8. The method of claim 5, wherein the quick connect fluid connector includes a piston that is slidably disposed within a body, and the first seal is located between the piston and the body.

9. The method of claim 5, wherein the gas flowing through the primary flow path is a high purity gas; and further comprising creating the first pressure differential zone by directing a flow of the high purity gas into the space between the first and second spaced sealing surfaces so that the first pressure differential zone has a pressure that is greater than ambient pressure.

10. The method of claim 5, further comprising creating the first pressure differential zone by directing a vacuum into the space between the first and second spaced sealing surfaces so that the first pressure differential zone has a pressure that is less than ambient pressure.

11. The method of claim 5, further comprising:
while the gas is flowing through the primary flow path, creating a second pressure differential zone adjacent to a second seal of the quick connect fluid connector by directing a flow of gas or vacuum adjacent to the second seal through a secondary flow path of the quick connect fluid connector, the second pressure differential zone having a pressure that differs from ambient pressure.

12. The method of claim 11, wherein the first pressure differential zone and the second pressure differential zone are spaced from one another along a longitudinal axis of the quick connect fluid connector.

13. A quick connect fluid connector that is detachably connectable to a fluid system to process a gas into or from the fluid system through the quick connect fluid connector, comprising:
a connection mechanism having a connected position to detachably connect the quick connect fluid connector to the fluid system and disconnected position to disconnect the quick connect fluid connector from the fluid system;
an actuator connected to the connection mechanism to actuate the connection mechanism between the connected position and the disconnected position;
a primary flow path through the quick connect fluid connector for the gas to flow through while the gas is processed into or from the fluid system;
a first seal disposed along a first sealing zone of the quick connect fluid connector, the first sealing zone is in fluid communication with ambient pressure;
a secondary flow path that extends to the first seal and that is fluidly connectable to a source of gas or to vacuum to create a first pressure differential zone adjacent to the first seal having a pressure that differs from ambient pressure.

14. The quick connect fluid connector of claim 13, wherein the first seal includes first and second spaced sealing surfaces defining a space therebetween, and the secondary flow path is in fluid communication with the space between the first and second spaced sealing surfaces.

15. The quick connect fluid connector of claim 13, wherein the first seal is located at an end of the quick connect fluid connector that during use is in sealing engagement with the fluid system via the first seal.

16. The quick connect fluid connector of claim 13, further including a piston that is slidably disposed within a body, and the first seal is located between the piston and the body.

17. The quick connect fluid connector of claim 13, further comprising:
a second seal disposed along a second sealing zone of the quick connect fluid connector, the second sealing zone is in fluid communication with ambient pressure;
a secondary flow path that extends to the second seal and that is fluidly connectable to a source of gas or to vacuum to create a second pressure differential zone adjacent to the second seal, the second pressure differential zone having a pressure that differs from ambient pressure.

18. The quick connect fluid connector of claim 17, wherein the first pressure differential zone and the second pressure differential zone are spaced from one another along a longitudinal axis of the quick connect fluid connector.
